(19) United States
(12) Patent Application Publication
(10) Pub. No.: US 2020/0210912 A1
(43) Pub. Date: Jul. 2, 2020

(54) INTEGRATED SOLUTION FOR SAFE OPERATING WORK SPACE

(71) Applicant: Saudi Arabian Oil Company, Dhahran (SA)

(72) Inventors: Eyad A. Buhulaiga, Alkhobar (SA); Hamdy A. Noureldin, Khobar (SA); Mohammed Tomehy, Khobar (SA)

(21) Appl. No.: 16/235,447

(22) Filed: Dec. 28, 2018

(51) Int. Cl. G06Q 10/06; G06Q 10/00; G05B 9/02; G08B 21/02

(52) U.S. Cl. CPC G06Q 10/0635; G06Q 10/06311; G08B 21/02; G05B 9/02; G06Q 10/20

(57) ABSTRACT

An integrated solution for safe operating work spaces includes systems and a computer-implemented method including the following. Information related to safety and operation of a harsh environment operation is received at a safe operating work space integration system (SOWSIS) from a plurality of non-integrated systems. The received information is analyzed by the SOWSIS, including integrating the information received from the plurality of non-integrated systems and performing a risk-based and root cause analysis using the integrated information. Actions to be performed are determined by the SOWSIS based on the analyzing and the integrated information. The actions are related to safety of the harsh environment operation. The actions are implemented by the SOWSIS.

### BACKGROUND

The present disclosure applies to providing an integrated solution for safe operating work spaces. Conventional systems used in industries such as refining, petrochemicals, and manufacturing may operate assets within harsh environments. Such operations may mandate stringent process safety and operational risk management controls. The controls can be used to track and control risks and associated causes before an incident hazard occurs. The controls can also be used to mitigate consequences after a hazard or safety incidents occurs. Some controls may be used to avoid major hazards, incidents, and fatalities caused by asset failures, system failures, or human errors.

Many operating facilities use a set of scattered discipline-specific applications with different levels of automation varying from one facility to another. The data within these applications are typically accessed only by specialized personnel with minimal collaboration and interaction with other operating facilities and end users. The lack of collaboration and interaction can result in the following problems. Users may spend a significant amount of time trying to fetch the data from various data sources. Different degrees of reliability may exist, with a variance in the level of data quality (for example, raw data vs. validated and reconciled data) due to scattered data sources. A slow decision-making process can result, with many processes being reactive rather than proactive. Specialized training is often required for each discipline to make use of discipline-specific data. Different and non-standardized processes and practices may occur within the same organization and in each business unit. Reports that are created from such practices and systems are often rigid and static.

Some industry practices use a Swiss cheese model to identify overall risks associated with operational tasks. For example, each layer of defense can be represented by a slice of cheese. An objective of the Swiss cheese model is to ensure that tasks are performed with the minimum level of risk by minimizing the number of layers of defense violations. Process safety management practices may focus on either hard safety barriers or soft safety barriers. Hard safety barriers, for example, can be used to monitor safety critical assets and their optimal operating conditions set by an integrity operating window. This approach can require human intervention as the approach depends mainly on inspection rounds, visual observation, and time-based preventive maintenance tasks. Soft safety barriers, for example, can be used to monitor different types of work conditions (for example, hot, cold, and confined spaces) and associated precautions (for example, lockout, tag out, and isolation). This approach can be used to monitor the hard barrier status in the case where barrier management is included. However, this approach does not consider the status of the real-time data that might arise during the course of executing the tasks at hand.

### SUMMARY

The present disclosure describes techniques that can be used to provide an integrated solution for safe operating work spaces. In some implementations, a computer-implemented method, includes: receiving, at a safe operating work space integrated system (SOWSIS) from a plurality of non-integrated systems, information related to safety and operation of a harsh environment operation; analyzing, by the SOWSIS, the received information, including integrating the information received from the plurality of non-integrated systems and performing a risk-based and root cause analysis; determining, by the SOWSIS based on the analyzing, actions to be performed, the actions being related to safety of the harsh environment operation; and implementing, by the SOWSIS, the actions to be performed.

The previously described implementation is implementable using a computer-implemented method; a non-transitory, computer-readable medium storing computer-readable instructions to perform the computer-implemented method; and a computer-implemented system comprising a computer memory interoperably coupled with a hardware processor configured to perform the computer-implemented method using the instructions stored on the non-transitory, computer-readable medium.

The subject matter described in this specification can be implemented in particular implementations, so as to realize one or more of the following advantages. First, operational risks of scattered discipline-specific applications can be reduced. Second, a holistic approach can be used for overall process safety and operational risk management. Third, a single system can integrate multiple products that are used to meet objectives of reliability and integrity performance solutions. Fourth, operating facilities can become automated and proactive instead of depending on time-based inspection and maintenance tasks that do not take into account the dynamic status of assets that are impacted by the mode of operations or the risks of human errors. Fifth, the techniques can provide relevant users with data collected from different applications, saving time in collecting and validating the data.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1A is a diagram of a standard role-based dashboard, according to some implementations of the present disclosure.

FIG. 1B is a diagram of a standard role-based dashboard for mobile systems, according to some implementations of the present disclosure.

FIGS. 2A-2B are block diagrams collectively showing an example of an integrated system, according to some implementations of the present disclosure.

FIGS. 3A-3C are swim lane diagrams collectively showing an example process for operational risk management and work permitting solutions, according to some implementations of the present disclosure.

FIGS. 4A-4B are swim lane diagrams collectively showing an example safety work flow, according to some implementations of the present disclosure.

FIG. 5 is a flowchart of an example method for providing an integrated solution for safe operating work spaces, according to some implementations of the present disclosure.

FIG. 6 is a block diagram illustrating an example computer system used to provide computational functionalities associated with described algorithms, methods, functions, processes, flows, and procedures as described in the instant disclosure, according to some implementations of the present disclosure.

Like reference numbers and designations in the various drawings indicate like elements.

### DETAILED DESCRIPTION

The following detailed description describes techniques for providing an integrated solution for safe operating work spaces. For example, the techniques can be used to monitor, analyze, and automate the management of process safety and operation risks in oil and gas processing organizations to provide proactive and corrective actions and to mitigate risks. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

The techniques described in the present disclosure can provide a comprehensive solution that improves current practices. The improvements can be achieved by integrating hard safety barriers and their associated integrity assurance tasks, including structural, process containment, ignition control, detection systems, protection systems, shutdown systems, emergency response systems, and lifesaving systems. The improvements can be achieved by integrating soft safety barriers and their associated precautions, including hot work permits, cold work permits, confined space work permits, and equipment opening work permits.

The techniques described in the present disclosure can improve asset health and performance. The techniques can use real-time operational data (for example, pressure, temperature, flow, and fire pump status) and data acquired from visual observations and operation rounds (for example, gas tests, safety system status, and noise detection). The use of predictive analytics using big data concepts can help to detect problems (for example, rotating equipment performance degradation, over pressure, and excursion temperature). The techniques can use predictive fault modeling scenarios (for example, fouling, vibration, and fire sprinkler failure) associated with fault precursors, root causes, and corrective actions. The techniques can help to prevent the degradation of asset health over time that would otherwise lead to higher operating risks. As an example, the techniques can prevent heater fouling that may lead to tube rupture.

Risk-based mechanical integrity can also be improved, including integrity operating windows and optimum operating conditions. Dynamic targets can be implemented that allow for modifying the operating windows based on the operating conditions. For example, a plant may be designed for naphtha mode with a set of inspection frequency duration (for example, once every year). Dynamic targeting can increase the frequency of inspection, for example, once every 6 months, if the mode of operation is changed to diesel mode. The change can be warranted to account for a faster level of asset integrity degradation, for example, caused by an increase in the level of corrosive material used within the piping. Improvements can also apply to risk-based mechanical integrity, such as inspection dates, remaining life, and allowable thinning.

The techniques described in the present disclosure can reduce environmental and organizational risks. The risks can be associated, for example, with wind directions and corresponding impacts to specific tasks in adjacent areas. For example, an ignition source may exist in one area, and a flammable gas release may exist in an adjacent area. Each area's standalone risk might be low. However, by monitoring the impact of the wind direction, the overall risk can be determined to be high. Other risks that can be reduced, for example, may be associated with high noise areas and Hydrogen Sulfide (H2S) areas.

Human risks can also be reduced. Human risks can be associated with training and certification (for example, fit to work), planned work orders, employee turn-around, inspection activities (for example, to identify work load, worker stress, and worker fatigue levels), time of day, near-miss and safety recommendation implementation status, incident history, engineering knowledge, lessons learned, and risk appetite.

In some implementations, overall cumulative risks can be calculated. For example, an overall risk can arise based on the degradation of one or more monitored and interdependent barriers or conditions.

Real-time or near-real-time digital tracking of proactive and predictive key process indicators (KPIs), barrier status, and accumulated residual risk can occur. For example, techniques can be used to perform risk-based and root cause analysis of near miss-barrier impairment and safety incidents. The techniques can also be used to generate corrective actions, emergency response, and electronic permits to work. The techniques can provide comprehensive and unique process safety solutions and associated digitalized information, operation and engineering technologies with scientific and execution methodologies. The methodologies can be used to monitor end-to-end business processes of overall process safety and operational risk management.

A holistic approach can be used to provide process safety and operational risk management, including providing a near real-time monitoring to all barriers and associated parameters that contribute to overall operational risks. The holistic approach can integrate the risk impact of any of those barriers and provide a real-time notification of root causes and corrective actions. The holistic approach can optimize schedules of work permits and automate the management of issuing work permits. The holistic approach can be used to automatically confiscate work permits based on changes in the status of safety barriers. The following paragraphs describe specific distinctions of the present disclosure.

First, the process safety and operation risk design and execution methodology and associated documentation and diagrams can be identified. This includes developing the integrated business process modeling (BPM) of the safe operating space with functional decomposition and sequential execution and workflow. An integrated solution architecture of the required software platform technologies can then be developed. This also includes developing data flow models and integration matrices for data attributes among the different sources and destination software platform technologies. Service-based integration models can be developed with message routing and associated situation management to pass messages among the different sources and destination software platform technologies. User-based information models can be developed with tasks, data, execution sequencing, software platform technologies, and associated N-dimension (for example, 5-dimension) swim lane diagrams.

Second, the following monitoring and tracking process safety and operation risk functions and associated integration of data, KPIs, and events are identified. Processes can include the identification and quantification of layer of protection analysis (LOPA)-based initiating events, leading and lagging process safety KPIs, safety incidents, and near-miss events. Other contributing parameters can be identified and quantified that might impact the work place safety including, for example, work load, human resources capabilities, asset history, wind directions and corresponding impacts on specific tasks in adjacent areas, and asset remaining life. Critical safety elements (CSEs), soft and hard safety barriers, and accumulated residual risk can be identified and tracked. Safety preparedness, safety incidents and emergencies, vapor and fire clouds, and responses to emergencies can be identified and tracked.

Third, identification can occur for the following analysis and execution process safety and operation risk functions and associated integration of data, KPIs, events, and associated parameters. The identification can prevent hazardous incidents from happening. Proactive operations can be provided and performed to identify latent and initial loss of performance that impact deterioration of process safety and increased operation risk. Predictive intelligent analysis can be provided and performed to identify correlated events that could occur that may drive or trigger safety incidents and emergencies. Proactive and reactive visualization analysis can be provided and performed to capture trends of key safety parameters on the safety envelope of the integrity operating windows (IOW). Reactive post mortem analysis can be provided and performed to identify best historical practices and data clusters of shutdowns, safety incidents, and emergencies. Reactive variance analysis can be provided and performed to identify performance violations of process safety data, KPIs, and events. Root cause analysis can be provided and performed on the degradation of safety preventative controls, including assets, humans, systems, and business processes, to eliminate and minimize risks associated with hard safety barriers and soft safety barriers.

Fourth, integration safety and operation risk requirements can be identified. The identification can include, for example, quantifying a particular risk based on the type of work being done (soft safety barriers), integrating operations, reliability, integrity and safety functions and associated data, KPIs, and events. Quantification can integrate both hard and soft safety barriers and identify contributing parameters, for example, integrating electronic permit-to-work with the plant maintenance work orders, integrating operating window vitalization and other process safety and operation risk functions and data, and integrating vapor cloud modeling and global position system (GPS) location information.

Fifth, process safety and operation risk compliance can be ensured. The safety and operation risk compliance can apply to asset integrity, hard barriers, health status, job hazard analysis (JHA), and electronic permit-to-work (EPTW) based on the optimized schedule and degree of risk after considering the data/tasks from all team members (for example, maintenance, engineering, and operations workers). The safety and operation risk compliance can apply to optimum execution of maintenance work orders based on the status and availability of the safeguards, economic operation and associated econometrics, and process safety operational expenditures (OPEX) such as clean out, asset replacement, and insurance premiums.

Sixth, new digitization technologies for process safety and operation risk can be identified, provided, and configured, including the following. Real-time and transactional monitoring technologies can be used to proactively and reactively track hard and soft barrier status and impairments. The real-time and transactional monitoring technologies can include distributed control systems (DCS), hand held monitors (HHM), smart phones, predictive inferential modeling systems (PIMS), video analytics, and plant maintenance. Other technologies that are used can include production, integrity, and reliability repository technologies for generating process safety and risk KPIs. Events can be tracked using long-term data archiving software, reliability and integrity software, and performance tracking and analysis software. Advanced analytics technologies can be used to correlate and predict process safety and risk events. The technologies can include complex event processing (CEP) and rule-based on-line fault modeling software. The technologies can also include the use of big data, artificial intelligence, and cognitive analysis software. Simulation and modeling techniques can include the use of process simulation, modeling, and what-if analysis software to track operation modes. Vapor and fire cloud modeling software can be used to track directions of clouds as functions of wind direction and ambient temperature and humidity. Visualization technologies can include the use of business intelligence (BI) software with on line analytical processing (OLAP), intelligent IOW software, and document management system (DMS) software. The technologies can also include integration technologies and enterprise/application service bus (ESB) technologies based on service oriented architecture (SOA).

Techniques that provide an integrated solution for process safety and operational risk management can include the following objectives. Processes can be used for managing process safety LOPA, incidents, root cause analysis, job safety analysis, work permitting, and regulatory compliance activities. Users can be supported in their performance of operational risk management and work permitting activities. Processes can be used for monitoring and displaying information regarding compliance with hazard and safety thresholds, as set by regulatory or company standards or procedures. Planned preventative maintenance (PM) and test and inspect (T&I) tasks can be retrieved. Job safety analysis (JSA) and job hazard analysis (JHA) can be conducted. Schedules can be updated with risk-mitigating tasks to mitigate risks associated with the type of job, workload, and impaired barrier status. Readings from gas test analyzers can be retrieved. Statuses of fire pumps, H2S systems, process safety barrier impairments, and other safety systems can be retrieved, for example, for use in determining whether a protection system deluge or a detection system gas detector are out of service. Three-dimensional (3D) asset virtualization (3DAV) and plot plans can be updated with color coding, associated risks, high noise areas, H2S concentrations, and barriers impaired. Planned work orders and tasks can be visually mapped on plant plots, including highlighting workloads, types of work permits, and barrier impairments. Cumulative risk indicators can be correlated with barrier impairments and detected conflicts. Operational risks can be proactively mitigated, and schedules can be optimized accordingly, both dynamically and graphically. What-if scenarios can be provided to help users evaluate the risks if conditions change, for example, over different shifts, different barrier impairment conditions, and completed adjacent job orders. Users can conduct task simulations, risk assessments, what-if scenarios, and route simulations (for example, to check for potential crashes and interference) and crane maneuvering simulations (for example, to determine the safest plan within a 3D model). The optimized schedule and associated extra precaution/operation instruction can be uploaded to PM and or T&I tasks. Hot work, cold work, and electrical work areas can be mapped and color-coded on 3D asset virtualization and plot plans, and access can be provided to users of all work permit data in the decision support and visualization (DSV) system. Users can be allowed to initiate work permitting from the optimized schedule with associated risks and precautions. Historical approved work permit data can be retrieved, and users can be allowed to analyze work permit issuer risk appetite (for example, adverse, minimal, caution, or open). Selected users can be notified by email if the number of high risk work permits exceeds allowable limits. DSV can alert selected users by email if KPIs deviate from the target.

Techniques described in the present disclosure can bridge the automation gap by maximizing the use of existing applications in the plants and by providing solutions to cover the missing functionalities through seamless integration into a single system. Scientific methodologies can be used to provide end-to-end business processes to ensure a safe operating work space including the following. The overall safety performance of assets, humans, systems, and business processes (hard barriers) can be defined and monitored to eliminate and minimize risk. Risks based on the type of work (soft barriers) can be quantified. Work permits can be automatically confiscated in case of a change in the status of safety barriers (hard or soft). Other contributing parameters can be identified that might impact work place safety. For example, impacts can be based on workloads, human resources capabilities, asset history, wind directions and corresponding impacts of specific tasks on adjacent areas, and asset remaining life. Both hard and soft safety barriers can be integrated along with contributing parameters to optimize work orders based on the status and availability of the safeguards. Work permits can be issued based on optimized schedules after considering the data and tasks from all team members in maintenance, engineering, and operations. Operations can move from being reactive and responding to incident into being proactive and preventing incidents from happening by providing a real-time monitoring of the safety performance indicators.

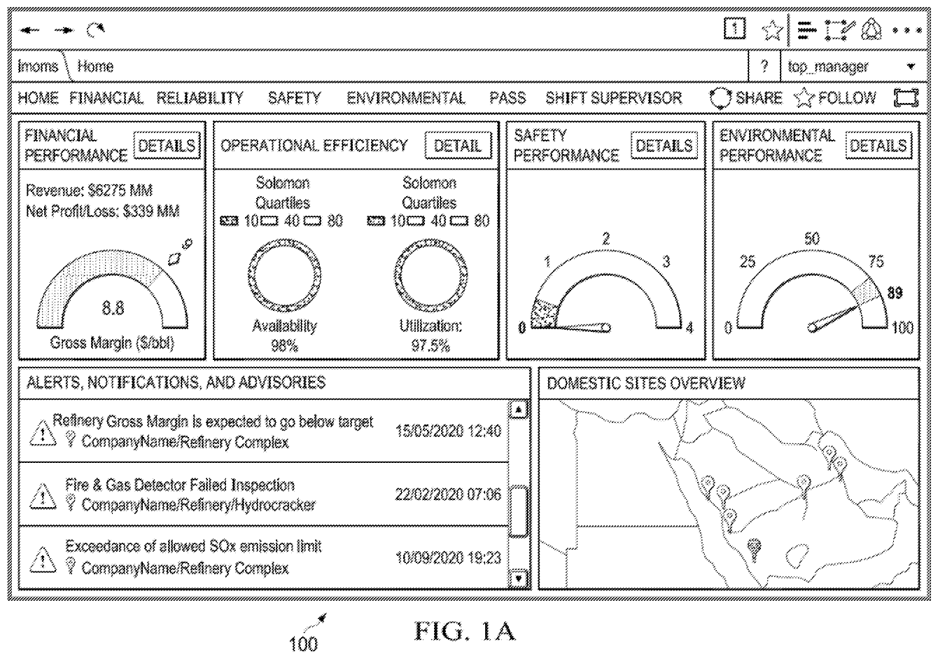

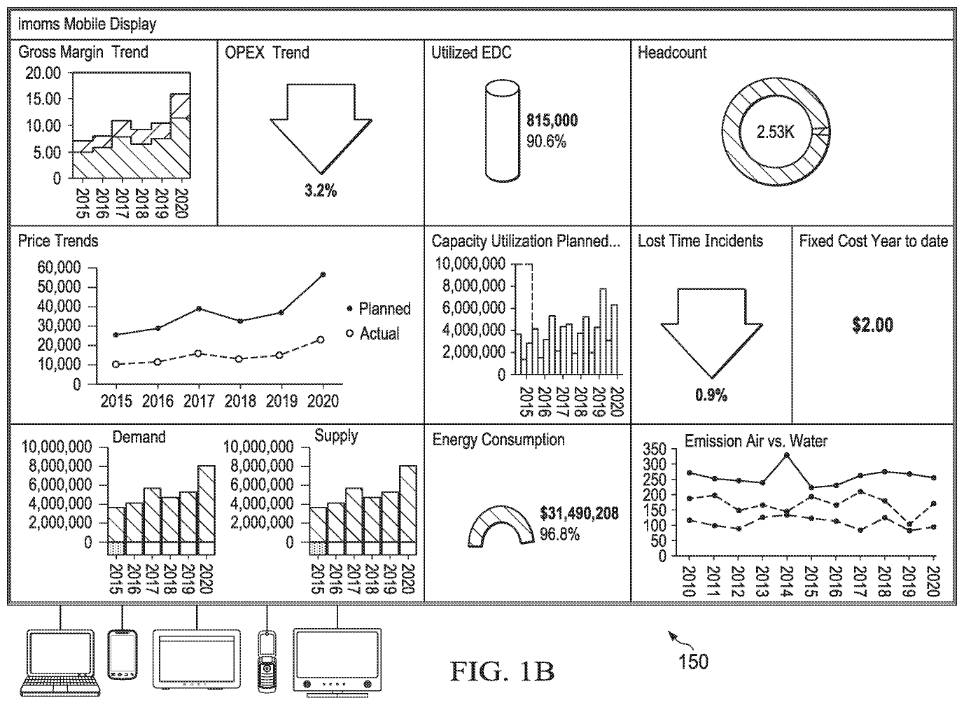

FIG. 1A is a diagram of a standard role-based dashboard 100, according to some implementations of the present disclosure. FIG. 1B is a diagram of a standard role-based dashboard 150 for mobile systems, according to some implementations of the present disclosure. While the dashboards 100 and 150 provide specific information, the dashboards 100 and 150 do not provide information for an integrated safe operating work space integration system using information from a several non-integrated systems.

An integrated safe operating work space integration system can provide, for example, relevant validated data, schedule optimization, and automation of work permit management can be provided to relevant users in a single system for coordinated and combined analysis. Techniques of the present disclosure can integrate existing applications within the plants and bridge the automation gap in order to maximize the utilization of the available data and allowing the relevant users to access these data through single system and their mobiles to make more profitable asset related decisions.

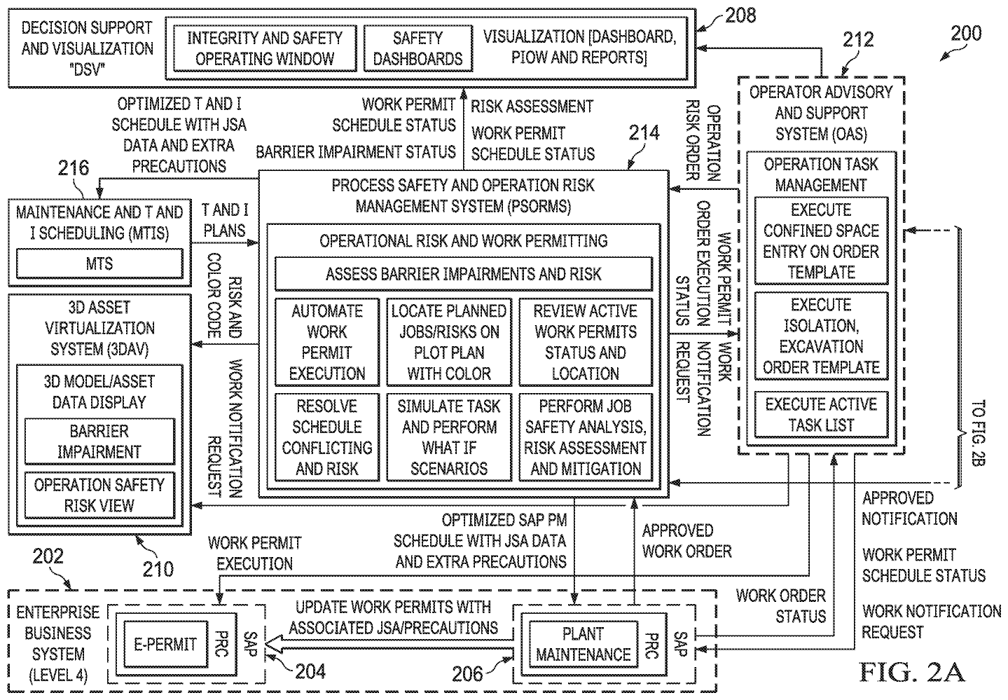

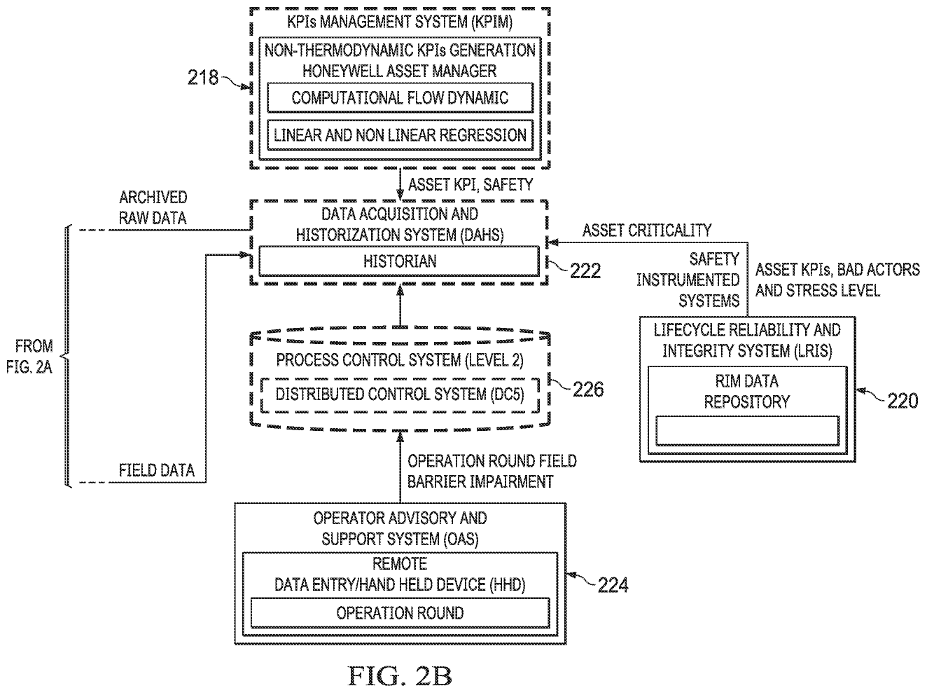

FIGS. 2A-2B are block diagrams collectively showing an example of an integrated system 200, according to some implementations of the present disclosure. The integrated system 200 can integrate the systems 206-226, including to provide or support techniques described in the present disclosure.

An enterprise business system 202 can interface with a professional regulatory commission (PRC) system 204 for handling e-permits and a PRC system 206 for handling plant maintenance. A decision support and visualization system (DSV) 208 can provide visualization information (for example, in dashboards, plant integrity operating window (PIOW) and reports). The visualization information can include, for example, integrity and safety operating window and safety dashboards information. A 3D asset visualization (3DAV) system 210 can include a 3D model/asset data display that provides barrier impairment information and operator safety risk view information.

An operator advisory and support (OAS) system 212 can perform operation task management. The OAS system 212 can perform operations including an execute confined space entry on an order template operation, an execute isolation/excavation order template operation, and an execute active task list operation. A process safety and operational risk management system (PSORMS) 214 can perform operational risk and work permitting. The PSORMS 214 can perform operations including an automate work permit execution operation, an asset barrier impairments and risk operation, a resolve schedule conflicting and risk operation, a review active work permits status and location operation, a locate planned jobs/risks on plot plan with color-coding operation, a simulate task and perform what-if scenarios operation, and a perform job safety analysis, risk assessment, and mitigation operation.

A maintenance and T&I scheduling (MTIS) system 216 can perform maintenance and T&I scheduling. A KPIs management (KPIM) system 218 can perform non-thermodynamic KPIs generation (for example, using an asset manager). The KPIM system 218 can perform operations including a computational flow dynamic operation and a linear and nonlinear recognition operation. A lifecycle reliability and integrity system (LRIS) 220 can maintain an integrity and limit data repository. The LRIS 220 can provide a repository for reliability and integrity-related information at the plant level and across the entire site. The LRIS 220 can feed the company's plant maintenance system and decision support and the visualization subsystem of the integrated system 200 with reliability-related performance data for further analytical purposes and follow-up. A data acquisition and historization system (DAHS) 222 can include a historian function. An operator advisory and support (OAS) system 224 can include a remote data entry system that performs operation round tasks. A process control system 226 can include a distributed control system (DCS).

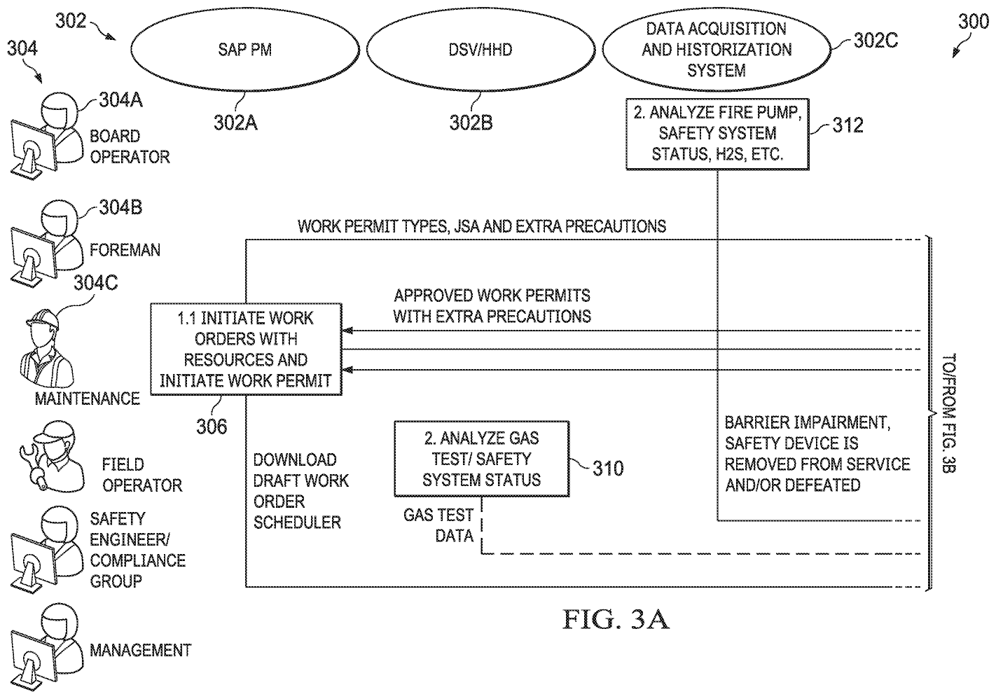

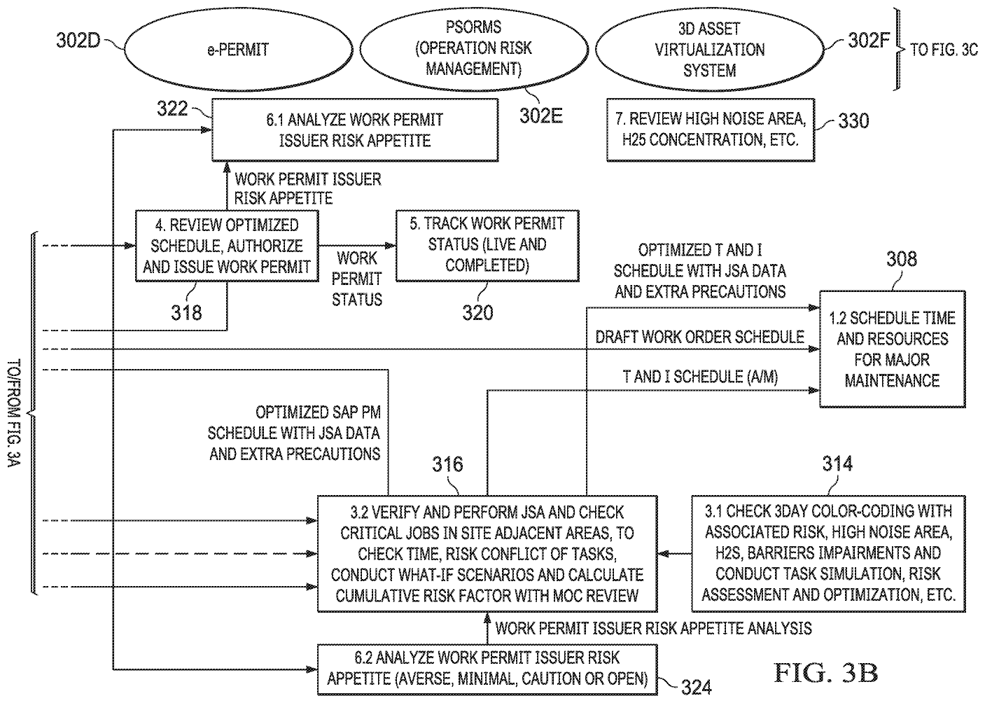

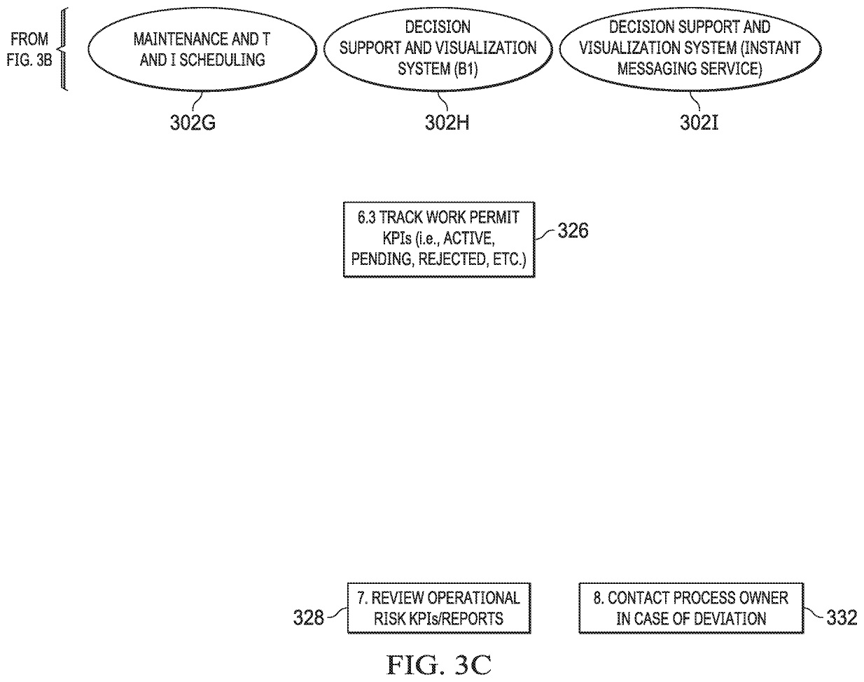

FIGS. 3A-3C are swim lane diagrams collectively showing an example process 300 for operational risk management and work permitting solutions, according to some implementations of the present disclosure. The process 300 can be executed, at least in part, by users 304. For example, the users 304 can include a board operator 304a, a foreman 304b, a maintenance worker 304c, a field operator 304d, a safety engineer or compliance group 304e, and management personnel 304f. Operations performed by the users 304 correspond to, and can be executed at least in part by, systems 302. The systems 302 include a plant maintenance system 302a, a DSV handheld monitoring system 302b, a data acquisition and historization system 302c, an e-permit system 302d, an operation risk management system 302e, a 3D asset virtualization system 302f, a maintenance and T&I scheduling system 302g, a decision support and visualization system 302h, and a decision support and visualization system messaging service 302i.

Operations 306-332 of the process 300 can be performed by the users 304 in accordance with the systems 302, as shown in FIGS. 3A-3C by locations of the operations 306-332 relative to the users 304a-304f and the systems 302a-302i. In operation 306, work orders and work permits are initiated. In operation 308, time and resources are scheduled for maintenance. In operation 310, gas tests and safety system status are analyzed. In operation 312, fire pump status, safety system status, and H2S status are analyzed. In operation 314, 3DAV color coding is checked with associated risks, high noise areas, H2S, and barriers impairments. Task simulation, risk assessment, and optimization are also conducted.

In operation 316, JSA is verified and performed, and critical jobs are checked in adjacent areas. Also, time and risk conflicts of tasks are checked, what-if scenarios are conducted, and cumulative risk factors are calculated for management of change (MOC) review. In operation 318, optimized schedules are reviewed and work permits are authorized and issued. In operation 320, work permit statuses (live and completed) are tracked. In operation 322, work permit issuer risk appetites are analyzed. At operation 324, work permit issuer risk appetites are analyzed for adverse, minimal, caution, and open factors. At operation 326, work permit KPIs are tracked relative to active, pending, and rejected statistics. At operation 328, operational risk and reports are reviewed. At operation 330, high noise areas and H2S concentrations are reviewed. At operation 332, process owners are contacted in the event of a deviation.

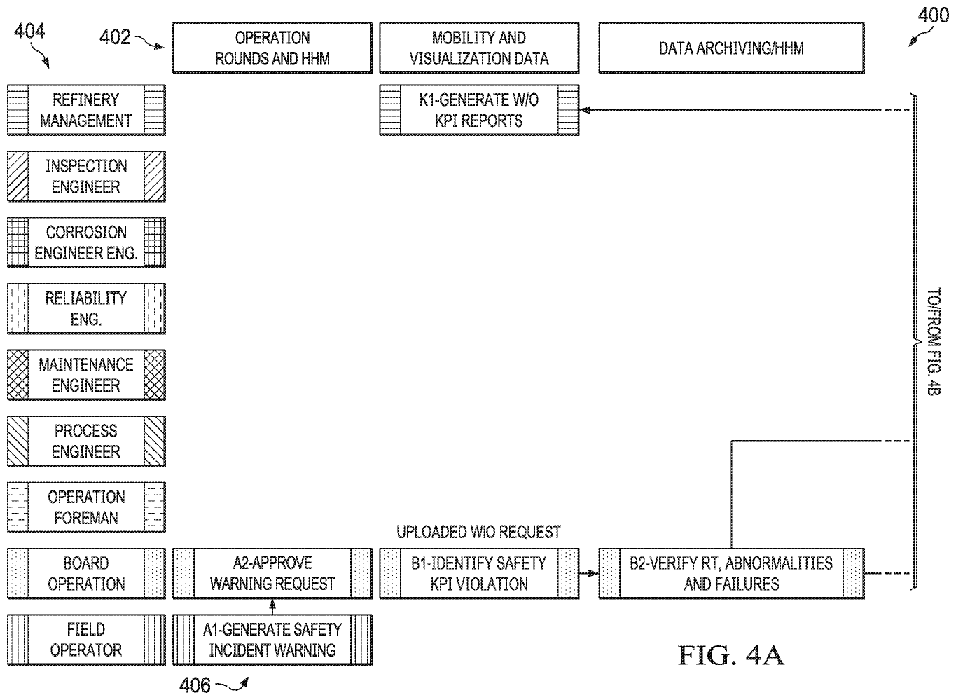

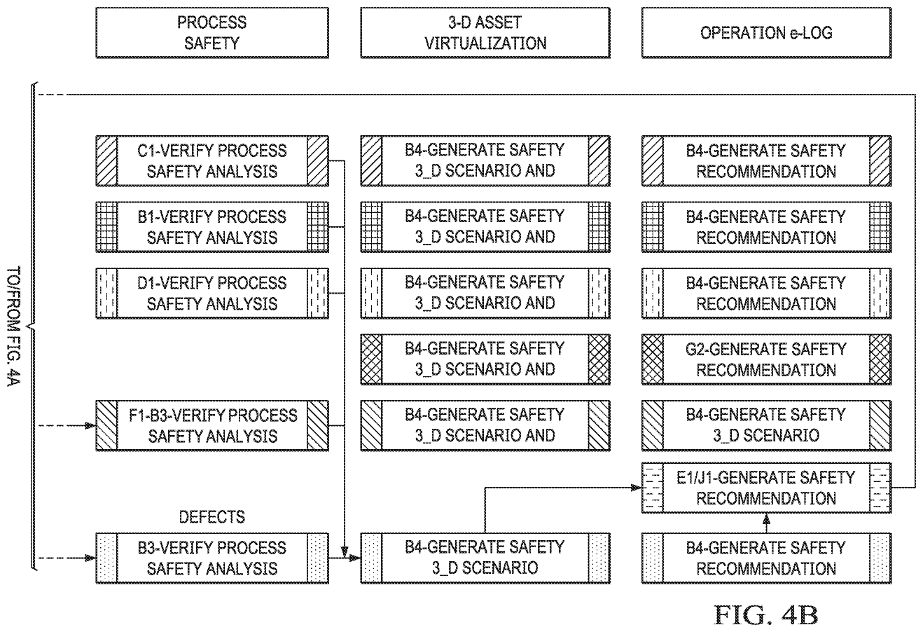

FIGS. 4A-4B are swim lane diagrams collectively showing an example safety work flow 400, according to some implementations of the present disclosure. The safety work flow 400 can include participation by systems 402, including operation rounds, mobility and data visualization, data archiving, process safety, 3D asset visualization, and operation e-logs. The safety work flow 400 can include participation by users 404 including refinery management, inspection engineers, corrosion engineers, reliability engineers, maintenance engineers, process engineers, operation foremen, board operation staff, and field operators. Operations 406 of the safety work flow 400 can include generating work order KPI reports, verifying process safety, generating safety 3D scenarios, generating safety recommendations, verifying process safety analysis, approving warning requests, identifying safety violations, verifying anomalies, and generating safety/incident warnings.

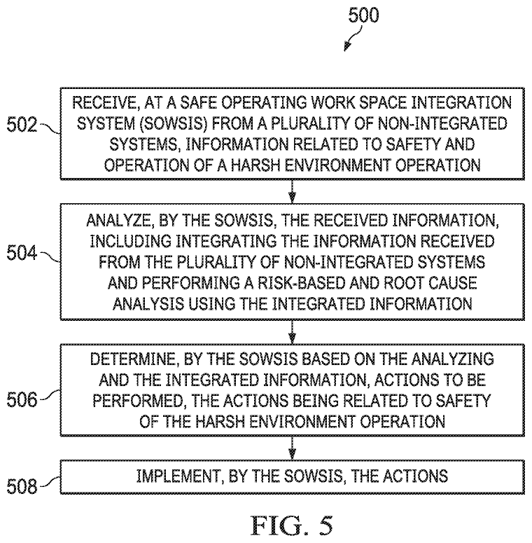

FIG. 5 is a flowchart of an example method 500 for providing an integrated solution for safe operating work spaces, according to some implementations of the present disclosure. For clarity of presentation, the description that follows generally describes method 500 in the context of the other figures in this description. However, it will be understood that method 500 may be performed, for example, by any suitable system, environment, software, and hardware, or a combination of systems, environments, software, and hardware, as appropriate. In some implementations, various steps of method 500 can be run in parallel, in combination, in loops, or in any order.

At 502, information related to safety and operation of a harsh environment operation is received at a safe operating work space integration system (SOWSIS) from a plurality of non-integrated systems. For example, the enterprise business system 202 can receive information from one or more of the systems 206-226. Harsh environments can include areas, operations, and facilities that include one or more factors that are harsh to equipment or humans, such as factors related to temperature, wind, moisture, chemicals, radioactivity, and mechanical stresses. From 502, method 500 proceeds to 504.

At 504, the received information is analyzed by the SOWSIS, including integrating the information received from the plurality of non-integrated systems and performing a risk-based and root cause analysis using the integrated information. As an example, the enterprise business system 202 can analyze the information received from one or more of the systems 206-226. From 504, method 500 proceeds to 506.

At 506, actions to be performed are determined by the SOWSIS based on the analyzing and the integrated information, the actions being related to safety of the harsh environment operation. For example, the enterprise business system 202 can identify actions to perform based on analyzing the information received from one or more of the systems 206-226. From 506, method 500 proceeds to 508.

At 508, the actions are implemented by the SOWSIS. As an example, the enterprise business system 202 can implement the actions to be performed. The actions that are implemented can be consistent with techniques described in the present disclosure. The actions can include, for example, automatically generating an overall maintenance plan to allow selection of an optimum time to schedule and reschedule tasks. This can allow optimum execution of maintenance work orders based on the status and availability of the safeguards, economic operation and associated econometrics, and process safety operational expenditures (OPEX) such as clean out, asset replacement, and insurance premiums. The actions can also include automatically generating an operation risk management schedule, automatically confiscating work permits when a status of safety barriers changes, automatically notifying selected users by email when a number of high-risk work permits exceeds allowable limits, automatically notifying maintenance personnel to perform corrective actions, and automatically notifying a responder of initiate emergency responses. After 508, method 500 stops.

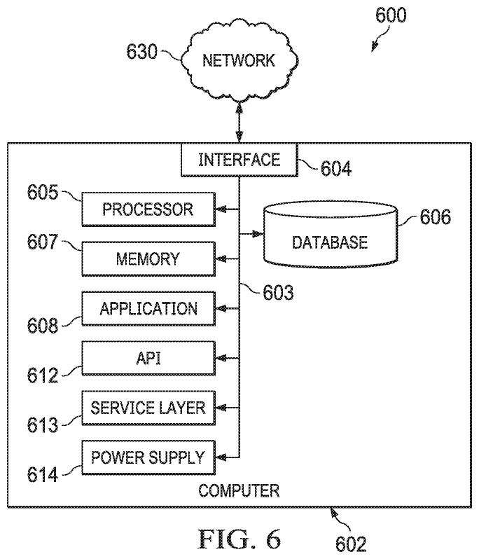

FIG. 6 is a block diagram of an example computer system 600 used to provide computational functionalities associated with described algorithms, methods, functions, processes, flows, and procedures, as described in the instant disclosure, according to some implementations of the present disclosure. The illustrated computer 602 is intended to encompass any computing device such as a server, desktop computer, laptop/notebook computer, wireless data port, smart phone, personal data assistant (PDA), tablet computing device, one or more processors within these devices, or any other suitable processing device, including physical or virtual instances (or both) of the computing device. Additionally, the computer 602 may comprise a computer that includes an input device, such as a keypad, keyboard, a touch screen that can accept user information, and an output device that conveys information associated with the operation of the computer 602, including digital data, visual, or audio information (or a combination of information), or a graphical-type user interface (UI) (or GUI).

The computer 602 can serve in a role as a client, network component, a server, a database, a persistency, or components of a computer system for performing the subject matter described in the instant disclosure. The illustrated computer 602 is communicably coupled with a network 630. In some implementations, one or more components of the computer 602 may be configured to operate within environments including cloud-computing-based environments, local environments, global environments, or any combination of environments.

At a high level, the computer 602 is an electronic computing device operable to receive, transmit, process, store, or manage data and information associated with the described subject matter. According to some implementations, the computer 602 may also include or be communicably coupled with an application server, email server, web server, caching server, streaming data server, or a combination of servers.

The computer 602 can receive requests over network 630 from a client application (for example, executing on another computer 602) and respond to the received requests by processing the received requests using an appropriate software application(s). In addition, requests may also be sent to the computer 602 from internal users (for example, from a command console or by other appropriate access method), external users, third parties, other automated applications, or any other appropriate entities, individuals, systems, or computers.

Each of the components of the computer 602 can communicate using a system bus 603. In some implementations, any or all of the components of the computer 602, hardware or software (or a combination of both hardware and software), may interface with each other or the interface 604 (or a combination of both), over the system bus 603 using an application programming interface (API) 612 or a service layer 613 (or a combination of the API 612 and service layer 613). The API 612 may include specifications for routines, data structures, and object classes. The API 612 may be either computer-language independent or dependent and refer to a complete interface, a single function, or even a set of APIs. The service layer 613 provides software services to the computer 602 and other components (whether illustrated or not) that are communicably coupled to the computer 602. The functionality of the computer 602 may be accessible for all service consumers using this service layer. Software services, such as those provided by the service layer 613, provide reusable, defined functionalities through a defined interface. For example, the interface may be software written in JAVA, C++, a language providing data in extensible markup language (XML) format, or any other suitable computer coding language. While illustrated as an integrated component of the computer 602, alternative implementations may illustrate the API 612 or the service layer 613 as stand-alone components in relation to other components of the computer 602 and other components communicably coupled to the computer 602. Moreover, any or all parts of the API 612 or the service layer 613 may be implemented as children or sub-modules of another software module, enterprise application, or hardware module without departing from the scope of this disclosure.

The computer 602 includes an interface 604. Although illustrated as a single interface 604 in FIG. 6, two or more interfaces 604 may be used according to particular needs, desires, or implementations of the computer 602. The interface 604 is used by the computer 602 for communicating with other systems that are connected to the network 630 (whether illustrated or not) in a distributed environment. Generally, the interface 604 comprises logic encoded in software or hardware (or a combination of software and hardware) and is operable to communicate with the network 630. More specifically, the interface 604 may comprise software supporting one or more communication protocols associated with communications such that the network 630 or interface's hardware is operable to communicate physical signals within and outside of the illustrated computer 602.

The computer 602 includes a processor 605. Although illustrated as a single processor 605 in FIG. 6, two or more processors may be used according to particular needs, desires, or particular implementations of the computer 602. Generally, the processor 605 executes instructions and manipulates data to perform the operations of the computer 602 and any algorithms, methods, functions, processes, flows, and procedures as described in the instant disclosure.

The computer 602 also includes a database 606 that can hold data for the computer 602 and other components connected to the network 630 (whether illustrated or not). For example, database 606 can be an in-memory, conventional, or a database storing data consistent with this disclosure. In some implementations, database 606 can be a combination of two or more different database types (for example, a hybrid in-memory and conventional database) according to particular needs, desires, or particular implementations of the computer 602 and the described functionality. Although illustrated as a single database 606 in FIG. 6, two or more databases (of the same or combination of types) can be used according to particular needs, desires, or particular implementations of the computer 602 and the described functionality. While database 606 is illustrated as an integral component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with this disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same or combination of types) can be used according to particular needs, desires, or particular implementations of the computer 602 and the described functionality. While memory 607 is illustrated as an integral component of the computer 602, in alternative implementations, memory 607 can be external to the computer 602.

The application 608 is an algorithmic software engine providing functionality according to particular needs, desires, or particular implementations of the computer 602, particularly with respect to functionality described in this disclosure. For example, application 608 can serve as one or more components, modules, or applications. Further, although illustrated as a single application 608, the application 608 may be implemented as multiple applications 608 on the computer 602. In addition, although illustrated as integral to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion or management circuits (including recharging, standby, or a power management functionality). In some implementations, the power-supply 614 can include a power plug to allow the computer 602 to be plugged into a wall socket or a power source to, for example, power the computer 602 or recharge a rechargeable battery.

There may be any number of computers 602 associated with, or external to, a computer system containing computer 602, each computer 602 communicating over network 630. Further, the term “client,” “user,” and other appropriate terminology may be used interchangeably, as appropriate, without departing from the scope of this disclosure. Moreover, this disclosure contemplates that many users may use one computer 602, or that one user may use multiple computers 602.

Described implementations of the subject matter can include one or more features, alone or in combination.

For example, in a first implementation, a computer-implemented method, comprising: receiving, at a safe operating work space integration system (SOWSIS) from a plurality of non-integrated systems, information related to safety and operation of a harsh environment operation; analyzing, by the SOWSIS, the received information, including integrating the information received from the plurality of non-integrated systems and performing a risk-based and root cause analysis; determining, by the SOWSIS based on the analyzing, actions to be performed, the actions being related to safety of the harsh environment operation; and implementing, by the SOWSIS, the actions to be performed.

The foregoing and other described implementations can each, optionally, include one or more of the following features:

A first feature, combinable with any of the following features, wherein the harsh environment operation is a refining operation or a petrochemical operation.

A second feature, combinable with any of the previous or following features, wherein the actions to be performed include corrective actions, emergency responses, and actions associated with electronic permits to work.

A third feature, combinable with any of the previous or following features, wherein the plurality of non-integrated systems provide information associated with hard safety barriers, soft safety barriers, asset health and performance, risk-based mechanical integrity, environmental and organizational risks, and human risks.

A fourth feature, combinable with any of the previous or following features, the method further comprising determining, by analyzing the received information, a cumulative risk for the harsh environment operation based on individual risks determined from the received information.

A fifth feature, combinable with any of the previous or following features, the method further comprising providing, for presentation to a user, real-time information associated with safe operation of a work space of the operation.

A sixth feature, combinable with any of the previous or following features, wherein the actions include: automatically generating an overall maintenance plan to allow selection of an optimum time to schedule and reschedule tasks; automatically generating an operation risk management schedule; automatically confiscating work permits when a status of safety barriers changes; automatically notifying selected users by email when a number of high-risk work permits exceeds allowable limits; automatically notifying maintenance personnel to perform corrective actions; and automatically notifying a responder of initiate emergency responses.

In a second implementation, a non-transitory, computer-readable medium storing one or more instructions executable by a computer system to perform operations comprising: receiving, at a safe operating work space integration system (SOWSIS) from a plurality of non-integrated systems, information related to safety and operation of a harsh environment operation; analyzing, by the SOWSIS, the received information, including integrating the information received from the plurality of non-integrated systems and performing a risk-based and root cause analysis; determining, by the SOWSIS based on the analyzing, actions to be performed, the actions being related to safety of the harsh environment operation; and implementing, by the SOWSIS, the actions to be performed.

The foregoing and other described implementations can each, optionally, include one or more of the following features:

A first feature, combinable with any of the following features, wherein the harsh environment operation is a refining operation or a petrochemical operation.

A second feature, combinable with any of the previous or following features, wherein the actions to be performed include corrective actions, emergency responses, and actions associated with electronic permits to work.

A third feature, combinable with any of the previous or following features, wherein the plurality of non-integrated systems provide information associated with hard safety barriers, soft safety barriers, asset health and performance, risk-based mechanical integrity, environmental and organizational risks, and human risks.

A fourth feature, combinable with any of the previous or following features, the operations further comprising determining, by analyzing the received information, a cumulative risk for the harsh environment operation based on individual risks determined from the received information.

A fifth feature, combinable with any of the previous or following features, the operations further comprising providing, for presentation to a user, real-time information associated with safe operation of a work space of the operation.

A sixth feature, combinable with any of the previous or following features, wherein the actions include: automatically generating an overall maintenance plan to allow selection of an optimum time to schedule and reschedule tasks; automatically generating an operation risk management schedule; automatically confiscating work permits when a status of safety barriers changes; automatically notifying selected users by email when a number of high-risk work permits exceeds allowable limits; automatically notifying maintenance personnel to perform corrective actions; and automatically notifying a responder of initiate emergency responses.

In a third implementation, a computer-implemented system, comprising one or more processors and a non-transitory computer-readable storage medium coupled to the one or more processors and storing programming instructions for execution by the one or more processors, the programming instructions instructing the one or more processors to perform operations comprising: receiving, at a safe operating work space integration system (SOWSIS) from a plurality of non-integrated systems, information related to safety and operation of a harsh environment operation; analyzing, by the SOWSIS, the received information, including integrating the information received from the plurality of non-integrated systems and performing a risk-based and root cause analysis; determining, by the SOWSIS based on the analyzing, actions to be performed, the actions being related to safety of the harsh environment operation; and implementing, by the SOWSIS, the actions to be performed.

The foregoing and other described implementations can each, optionally, include one or more of the following features:

A first feature, combinable with any of the following features, wherein the harsh environment operation is a refining operation or a petrochemical operation.

A second feature, combinable with any of the previous or following features, wherein the actions to be performed include corrective actions, emergency responses, and actions associated with electronic permits to work.

A third feature, combinable with any of the previous or following features, wherein the plurality of non-integrated systems provide information associated with hard safety barriers, soft safety barriers, asset health and performance, risk-based mechanical integrity, environmental and organizational risks, and human risks.

A fourth feature, combinable with any of the previous or following features, the operations further comprising determining, by analyzing the received information, a cumulative risk for the harsh environment operation based on individual risks determined from the received information.

A fifth feature, combinable with any of the previous or following features, wherein the actions include: automatically generating an overall maintenance plan to allow selection of an optimum time to schedule and reschedule tasks; automatically generating an operation risk management schedule; automatically confiscating work permits when a status of safety barriers changes; automatically notifying selected users by email when a number of high-risk work permits exceeds allowable limits; automatically notifying maintenance personnel to perform corrective actions; and automatically notifying a responder of initiate emergency responses.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS, or any other suitable conventional operating system.

A computer program, which may also be referred to or described as a program, software, a software application, a module, a software module, a script, or code can be written in any form of programming language, including compiled or interpreted languages, or declarative or procedural languages, and it can be deployed in any form, including as a stand-alone program or as a module, component, subroutine, or a unit for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or processes, the programs may instead include a number of sub-modules, third-party services, components, libraries, and such, as appropriate. Conversely, the features and functionality of various components can be combined into single components, as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data includes all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital video disc (DVD), CD-ROM, DVD+/-R, DVD-RAM, DVD-ROM, HD-DVD, and BLURAY, and other optical memory technologies. The memory may store various objects or data, including caches, classes, frameworks, applications, modules, backup data, jobs, web pages, web page templates, data structures, database tables, repositories storing dynamic information, and any other appropriate information including any parameters, variables, algorithms, instructions, rules, constraints, or references. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light-emitting diode (LED), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with some implementations of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 protocols), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or a combination of communication types between network addresses.

The computing system can include clients and servers. A client and server are generally remote from each other and typically interact through a communication network. The relationship of client and server arises by virtue of computer programs running on the respective computers and having a client-server relationship to each other.

Cluster file systems can be any file system type accessible from multiple servers for read and update. Locking or consistency tracking may not be necessary since the locking of exchange file system can be done at application layer. Furthermore, Unicode data files are different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain this disclosure. Other changes, substitutions, and alterations are also possible without departing from the spirit and scope of this disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, at a safe operating work space integration system (SOWSIS) from a plurality of non-integrated systems, information related to safety and operation of a harsh environment operation;
analyzing, by the SOWSIS, the received information, including integrating the information received from the plurality of non-integrated systems and performing a risk-based and root cause analysis;
determining, by the SOWSIS based on the analyzing, actions to be performed, the actions being related to safety of the harsh environment operation; and
implementing, by the SOWSIS, the actions to be performed.

2. The computer-implemented method of claim 1, wherein the harsh environment operation is a refining operation or a petrochemical operation.

3. The computer-implemented method of claim 1, wherein the actions to be performed include corrective actions, emergency responses, and actions associated with electronic permits to work.

4. The computer-implemented method of claim 1, wherein the plurality of non-integrated systems provide information associated with hard safety barriers, soft safety barriers, asset health and performance, risk-based mechanical integrity, environmental and organizational risks, and human risks.

5. The computer-implemented method of claim 1, further comprising determining, by analyzing the received information, a cumulative risk for the harsh environment operation based on individual risks determined from the received information.

6. The computer-implemented method of claim 1, further comprising providing, for presentation to a user, real-time information associated with safe operation of a work space of the operation.

7. The computer-implemented method of claim 1, wherein the actions include:
automatically generating an overall maintenance plan to allow selection of an optimum time to schedule and reschedule tasks;
automatically generating an operation risk management schedule;
automatically confiscating work permits when a status of safety barriers changes;
automatically notifying selected users by email when a number of high-risk work permits exceeds allowable limits;
automatically notifying maintenance personnel to perform corrective actions; and
automatically notifying a responder of initiate emergency responses.

8. A non-transitory, computer-readable medium storing one or more instructions executable by a computer system to perform operations comprising:
receiving, at a safe operating work space integration system (SOWSIS) from a plurality of non-integrated systems, information related to safety and operation of a harsh environment operation;
analyzing, by the SOWSIS, the received information, including integrating the information received from the plurality of non-integrated systems and performing a risk-based and root cause analysis;
determining, by the SOWSIS based on the analyzing, actions to be performed, the actions being related to safety of the harsh environment operation; and
implementing, by the SOWSIS, the actions to be performed.

9. The non-transitory, computer-readable medium of claim 8, wherein the harsh environment operation is a refining operation or a petrochemical operation.

10. The non-transitory, computer-readable medium of claim 8, wherein the actions to be performed include corrective actions, emergency responses, and actions associated with electronic permits to work.

11. The non-transitory, computer-readable medium of claim 8, wherein the plurality of non-integrated systems provide information associated with hard safety barriers, soft safety barriers, asset health and performance, risk-based mechanical integrity, environmental and organizational risks, and human risks.

12. The non-transitory, computer-readable medium of claim 8, the operations further comprising determining, by analyzing the received information, a cumulative risk for the harsh environment operation based on individual risks determined from the received information.

13. The non-transitory, computer-readable medium of claim 8, the operations further comprising providing, for presentation to a user, real-time information associated with safe operation of a work space of the operation.

14. The non-transitory, computer-readable medium of claim 8, wherein the actions include:
automatically generating an overall maintenance plan to allow selection of an optimum time to schedule and reschedule tasks;
automatically generating an operation risk management schedule;
automatically confiscating work permits when a status of safety barriers changes;
automatically notifying selected users by email when a number of high-risk work permits exceeds allowable limits;
automatically notifying maintenance personnel to perform corrective actions; and
automatically notifying a responder of initiate emergency responses.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving, at a safe operating work space integration system (SOWSIS) from a plurality of non-integrated systems, information related to safety and operation of a harsh environment operation;
analyzing, by the SOWSIS, the received information, including integrating the information received from the plurality of non-integrated systems and performing a risk-based and root cause analysis;
determining, by the SOWSIS based on the analyzing, actions to be performed, the actions being related to safety of the harsh environment operation; and
implementing, by the SOWSIS, the actions to be performed.

16. The computer-implemented system of claim 15, wherein the harsh environment operation is a refining operation or a petrochemical operation.

17. The computer-implemented system of claim 15, wherein the actions to be performed include corrective actions, emergency responses, and actions associated with electronic permits to work.

18. The computer-implemented system of claim 15, wherein the plurality of non-integrated systems provide information associated with hard safety barriers, soft safety barriers, asset health and performance, risk-based mechanical integrity, environmental and organizational risks, and human risks.

19. The computer-implemented system of claim 15, the operations further comprising determining, by analyzing the received information, a cumulative risk for the harsh environment operation based on individual risks determined from the received information.

20. The computer-implemented system of claim 15, wherein the actions include:
automatically generating an overall maintenance plan to allow selection of an optimum time to schedule and reschedule tasks;
automatically generating an operation risk management schedule;
automatically confiscating work permits when a status of safety barriers changes;
automatically notifying selected users by email when a number of high-risk work permits exceeds allowable limits;
automatically notifying maintenance personnel to perform corrective actions; and
automatically notifying a responder of initiate emergency responses.
